(19) United States
(12) Patent Application Publication
(10) Pub. No.: US 2009/0218133 A1
(43) Pub. Date: Sep. 3, 2009

(54) Cable Having Externally Joinable Outer Portion

(75) Inventors: Anthony Radice, Chalfont, PA (US); Anne Pearce, Barrington, IL (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/039,778

(22) Filed: Feb. 29, 2008

(51) Int. Cl. H02G 3/04; B32B 1/00; B29C 47/00

(52) U.S. Cl. 174/70 R; 264/176.1; 428/364

(57) ABSTRACT

In accordance with an aspect of the present invention, a device includes a cable having a periphery and an extrusion surrounding the periphery. The extrusion includes a main body portion, a male protrusion and a female indentation. The main body portion has an outer periphery. The male protrusion is disposed at the outer periphery. The female indentation is additionally disposed at the outer periphery. The device enables easy organization by connection of a plurality of cables, prevents entanglement of the plurality of cables, and enables easy removal of at least one cable from the plurality of cables without disrupting the organization of the remainder of the plurality cables.

### BACKGROUND

The prevalence of electronic devices, ranging from home theater systems to computers, has led to systems with many individual components. Each of these components may include or require the use of at least one cable for power or communication with at least one or more other components. As such, systems having many individual components typically require a multitude of cables to interconnect and power these devices. Since the number of cables increases with the number of components, a greater likelihood for cable entanglement is possible for multi-component systems.

One conventional method of arranging such a plurality of cables in a system of components is the use of one-way attachable straps. Specifically, a one-way attachable strap typically includes a head portion having a hole therein, a tail portion, and a bendable strap portion located between the head portion and the tail portion. The bendable strap portion typically has a plurality of barbs or locking sections and is looped around a plurality of bunched cables. The tail portion is then fed through the hole in the head portion of the one way attachable strap. Finally, the bendable strap potion is pulled through the hole until the plurality of cables is tightly held together. The barbs or locking sections of the bendable strap portion prohibit removal from the hole of the head portion.

Although useful in the organization of a collection of cables for a conventional home electronic system, typically, a plurality of such straps may be required to be spaced along a length of closely grouped cables to prevent entanglement. Further, the one-way attachable straps must be removed. Accordingly, if a cable within a system of components which uses one or more conventional one-way attachable straps needs to be moved, or even removed, at least one of the plurality of straps must be cut, or otherwise destroyed. Once one or more of the one-way attachable straps has been removed, the organization of the remainder of the plurality of cables is disrupted. Therefore, the organization of the plurality of cables in the system must be regrouped prior to being retained by a new strap.

FIG. 11 illustrates a typical set-up for a sound system using two cables. In the figure, a person 1114 watches television 1102 via receiver 1104. Receiver 1104 provides a right audio signal along a cable 1106 to a speaker 1110 and provides a left audio signal along a cable 1108 to a speaker 1112. Each of cables 1106 and 1108 travel a distance A from respective outputs of receiver 1104 to a first conventional one-way attachable strap. Cables 1106 and 1108 travel along a common distance and direction B, wherein they are typically connected together via a plurality of spaced conventional one-way attachable straps. A last conventional one-way attachable strap is disposed where the paths of cables 1106 and 1108 diverge, wherein cable 1106 travels a distance and direction C to speaker 1110 and wherein cable 1108 travels a distance and direction D to speaker 1112.

If either one of cable 1106 or cable 1108 needs to be replaced or moved, each of the conventional one-way attachable straps must be destroyed. Once moved or either one of cables 1106 or 1108 are moved or replaced, new conventional one-way attachable straps may need to be deployed to maintain the originally intended level of organization. Although this may not seem to be too much of a burden, the size of the burden increases dramatically as the number of cables increases, as discussed below with respect to FIG. 12.

FIG. 12 illustrates an underground communication cable system. In the figure, a tunnel 1202 is disposed below an urban street 1202 and is accessible via a ladder 1206 in a manhole 1208. A plurality of communication cables 1210 are strung along a wall or ceiling of tunnel 1202. The plurality of communication cables is held tightly together via a plurality of spaced one-way attachment straps 1212. In the event that one or more of the individual communication cables becomes damaged, the one-way attachable straps must be removed, the one or more individual cables must be removed or repaired, and new one-way attachable straps must then be applied. Although tightly bunched together via the one-way attachment straps 1212, the individual communication cables within the plurality of communication cables 1210 may become intertwined as they run the length of tunnel 1202. As such, separating any specific one or any specific plurality of cables for removal or repair becomes a lengthy process.

What is needed is a device that enables easy organization of a plurality of cables, prevents entanglement of the plurality of cables, and enables easy removal of at least one cable from the plurality of cables without disrupting the organization of the remainder of the plurality cables.

### BRIEF SUMMARY

It is an object of the present invention to provide a device that enables easy organization by connection of a plurality of cables, prevents entanglement of cables, and enables easy removal of at least one cable from the plurality of cables without disrupting the organization of the remainder of the plurality of cables.

In accordance with an aspect of the present invention, a device includes a cable having a periphery and an extrusion surrounding the periphery. The extrusion includes a main body portion, a male protrusion and a female indentation. The main body portion has an outer periphery. The male protrusion is disposed at the outer periphery. The female indentation is additionally disposed at the outer periphery.

In accordance with another aspect of the present invention, an extrusion includes a main body portion, a male protrusion and a female indentation. The main body portion has an outer periphery, a hollow core and a slit from the outer periphery to the hollow core. The male protrusion is disposed at the outer periphery. The female indentation is additionally disposed at the outer periphery.

Additional objects, advantages and novel features of the invention are set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates an oblique view of an extrusion in accordance with an exemplary embodiment of the present invention with one male protrusion and one female indentation;

FIG. 2 illustrates a cross-section of the extrusion of FIG. 1;

FIG. 3A illustrates the connection interface between two samples of an extrusion of FIG. 1, prior to connection;

FIG. 3B illustrates the connection interface between the two samples of an extrusion as illustrated in FIG. 3A, after connection;

FIG. 4A illustrates a portion of a cross-section of an extrusion in accordance with another exemplary embodiment of the present invention;

FIG. 4B illustrates a portion of a cross-section of another extrusion in accordance with another exemplary embodiment of the present invention;

FIG. 5 illustrates a cross-section of an extrusion in accordance with another exemplary embodiment of the present invention;

FIG. 6 illustrates an exemplary extrusion process in accordance with the present invention;

FIG. 7 illustrates a cross-section of an extrusion having a slit for interior access in accordance with another exemplary embodiment of the present invention;

FIG. 8 illustrates a cross-section of an extrusion having a slit for interior access in accordance with another exemplary embodiment of the present invention, wherein the slit has a male protrusion on one side and a female indentation on the other side for detachable connection;

FIG. 9 illustrates a cross-section of an extrusion having a slit for interior access in accordance with another exemplary embodiment of the present invention;

FIG. 10 illustrates another exemplary extrusion process in accordance with the present invention;

FIG. 11 illustrates a typical set-up for a sound system using two cables; and

FIG. 12 illustrates an underground communication cable system.

### DETAILED DESCRIPTION

The following description details several embodiments of the present invention as represented by the accompanying figures.

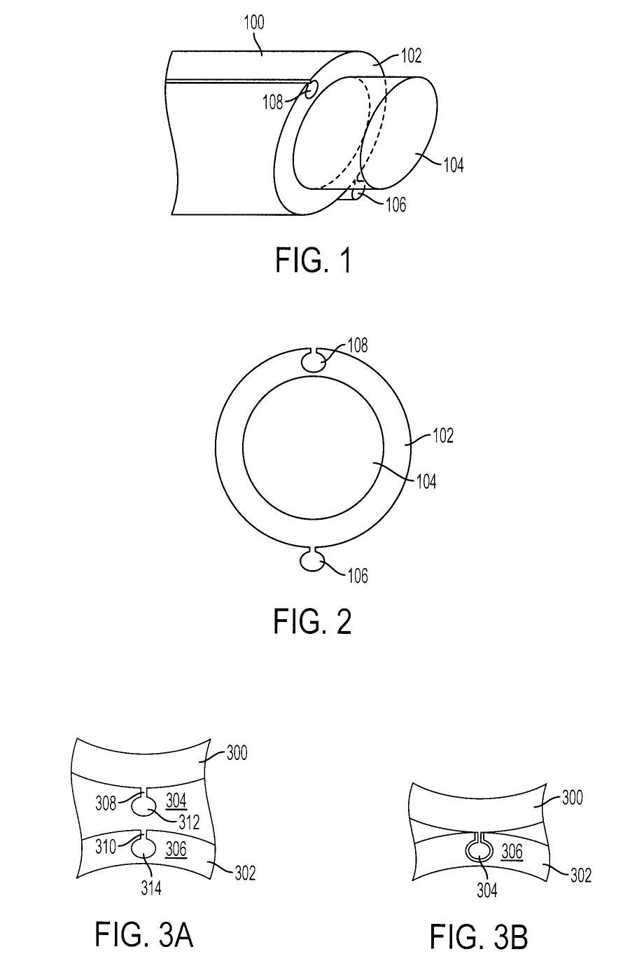

One exemplary embodiment of the present invention will now be described with reference to FIG. 1, FIG. 2 and FIGS. 3A and 3B.

FIG. 1 illustrates an oblique view of an extrusion in accordance with an exemplary embodiment of the present invention with one male protrusion and one female indentation. FIG. 2 illustrates a cross-section of the extrusion of FIG. 1.

In this embodiment, an extrusion 100 includes a main body portion 102 that surrounds a cable 104. Main body portion 102 includes a male protrusion 106 and a female indentation 108. Protrusion 106 and indentation 108 permit detachable connection with other extrusions of similar design, as discussed in more detail below. Further, cable 104 may comprise any type of cable, non-limiting examples of which include an electrically conducting coaxial cable, a fiber optic cable, a combined electrically conducting coaxial and fiber optic cable, a bundle of electrically conducting coaxial cables, a bundle of fiber optic cables and a bundle of combined electrically conducting coaxial and fiber optic cables.

FIGS. 3A and 3B illustrate connection between two extrusions as illustrated in FIG. 1. FIG. 3A shows a male protrusion 304 on a main body portion 300 of a first extrusion and a female indentation 306 on a main body portion 302 of another extrusion before connection. To connect the two extrusions, male protrusion 304 on main body portion 300 is inserted into female indentation 306 in main body portion 302 as seen in FIG. 3B. Once connected, the design of the male protrusion 304 and the female indentation 306 provides a resistance to disconnection as discussed in more detail below.

Male protrusion 304 includes a narrow section 308 and wide section 312. Narrow section 308 extends from main body portion 300 to wide section 312. Wide section 312 is much wider than narrow section 308. The shape of wide section 312 in FIG. 3A, is shown to have a circular cross-section.

Female indentation 306 includes narrow section 310 and a wide section 314. Narrow section 310 of female indentation 306 is of a sufficient size as to house narrow section 308 of male protrusion 304. Similarly, wide section 314 of female indentation 306 is of sufficient size and shape as to house wide section 312 of male indentation 304.

In FIG. 3B, male protrusion 304 fits into female indentation 306 and narrow section 310 of female indentation 306 provides resistance to retain wide section 312 of male protrusion 304 within wide section 314.

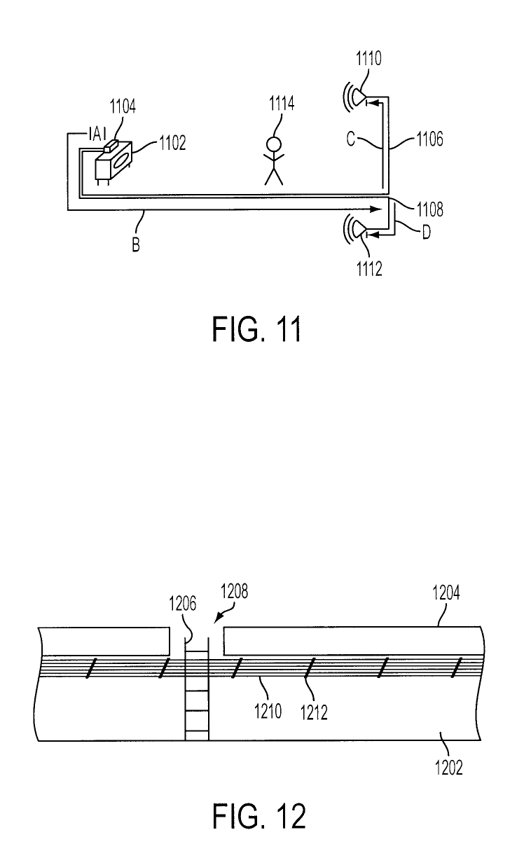

A cable with the extrusion in accordance with the present invention could quickly and easily be connected to another similar cable with an extrusion as discussed above. For example, returning to FIG. 11, suppose cables with extrusions were used in accordance with the present invention. In such a system, once the cables with extrusions were connected to each other along the common distance and direction B, the two cables may be manipulated as a single cable along the common distance and direction B to increase organization and eliminate tangling. Further, after connection, the two cables may be quickly and easily disconnected from one another in order to move or replace one or both cables.

The first embodiment of the present invention shows male protrusion 304 and female indentation 306 having respective wide portions 312 and 314 with a circular cross-section. Of course, any shape of cross section may be used so long as the width of the wide section is equal to or greater than the width of the narrow section, to facilitate detachable connection.

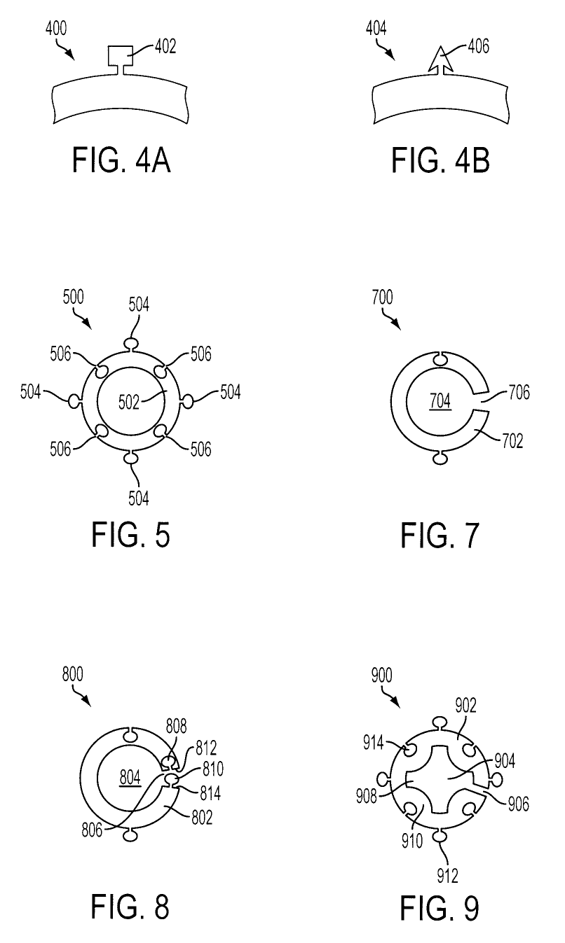

Two other exemplary embodiments of the present invention will now be described with reference to FIG. 4A and FIG. 4B.

FIG. 4A shows a wide section 402 of a male protrusion 400 with a square cross-section. For this embodiment, a corresponding female indentation would have a wide section with a size and shape sufficiently corresponding to wide section 402.

FIG. 4B shows a wide section 406 of a male protrusion 404 with a barb cross-section. For this embodiment, a corresponding female indentation would have a wide section with a size and shape sufficiently corresponding to wide section 406.

The exemplary embodiment discussed above with respect to FIG. 1 and FIG. 2 illustrate a single male protrusion and a single female indentation. Further, while main body portion 102 is illustrated to contain both male protrusion 106 and female indentation 108, those of skill in the art will appreciate that only one of them may be formed on main body portion 102, or multiple male protrusions 106 or female indentations 108 may be formed. As such, a cable with at least one male protrusion may be connected to/disconnected from another cable with one female indentation.

Male protrusion 106 and/or female indentation 108 may generally extend the length of cable 104. Alternatively, male protrusion 106 and/or female indentation may be formed along segments of portions of the length of cable 104. Likewise, only one of male protrusion 106 or female indentation 108 may be formed to generally extend along the length of cable 104, while the other is formed in segments or portions of the length of cable 104.

Other embodiments of the present invention include one male protrusion or one female indentation. As such, a cable with at least one male protrusion may be connected to/disconnected from another cable with one female indentation. Other embodiments of the present invention include a plurality of male protrusions, a plurality of female indentations and pluralities of both male protrusions and female indentations.

Another embodiment of the present invention that includes pluralities of both male protrusions and female indentations will now be described with reference to FIG. 5.

FIG. 5 illustrates a cross-section of an extrusion 500 that includes a plurality of male protrusions 504 and a plurality of female indentations 506 on a single main body portion 502. With this embodiment, one extrusion may be connected to up to eight other extrusions. Each of the four male protrusions 504 may be connected to a corresponding female indentation of another instance of an extrusion. Further, each of the four female indentations 506 may be connected to a corresponding male protrusion of another instance of an extrusion. Of course any number of male protrusions and any number of female indentations may be used. Further, any shape of cross-section may be used so long as the width of the wide section is equal to or greater than the width of the narrow section, to facilitate detachable connection.

A plurality of cables, each with an extrusion in accordance with the present invention, could quickly and easily be connected to other similar cables with extrusions as discussed above. For example, returning to FIG. 12, suppose cables with extrusions were used in accordance with the present invention. In such a system, once the cables with extrusions were connected to each other, the plurality of cables may be manipulated as a single cable along line 1210 to increase organization and eliminate tangling. Further, after connection, any number of cables may be quickly and easily disconnected from any of the other cables for removal or replacement.

An extrusion in accordance with the present invention may be fabricated by any extrusion technique known to those of skill in the art. Plastic extrusion commonly uses plastic chips or pellets, which are usually dried in a hopper before going to a feed screw. The chips or pellets form a polymer resin that is then heated to a molten state by a combination of heating elements and shear heating from the extrusion screw. The screw forces the resin through a die, forming the resin into the desired shape. The extrusion is cooled and solidified as it is pulled through the die or water tank. Non-limiting examples of plastic extrusion techniques include overjacketing extrusion techniques and tubing extrusion techniques.

In overjacketing extrusion techniques, such as in a cable coating process, bare cable (or bundles of jacketed cables, filaments, etc) is pulled through the center of a die similar to a tubing die. Many different materials are used for this purpose depending on the application. Essentially, an insulated cable is a thin walled tube which has been formed around a bare cable. There are two different types of extrusion tooling used for coating over a cable. They are referred to as either “pressure” or “jacketing” tooling. The selection criteria for choosing which type of tooling to use is based on whether the particular application requires intimate contact or adhesion of the polymer to the cable. If intimate contact or adhesion is required, pressure tooling is used. If it is not desired, jacketing tooling is chosen. The main difference in jacketing and pressure tooling is the position of the pin with respect to the die. For jacketing tooling, the pin will extend all the way flush with the die. When the bare cable is fed through the pin, it does not come in direct contact with the molten polymer until it leaves the die. For pressure tooling, the end of the pin is retracted inside the crosshead, where it comes in contact with the polymer at a much higher pressure.

In tubing extrusion techniques, plastic tubing, such as drinking straws and medical tubing, is manufactured by extruding molten polymer through a die of the desired profile shape (square, round, triangular). Hollow sections are usually extruded by placing a pin or mandrel inside of the die, and in most cases positive pressure is applied to the internal cavities through the pin. Sometimes tubing with multiple lumens (holes) must be made for specialty applications. For these applications, the tooling is made by placing more than one pin in the center of the die, to produce the number of lumens necessary. In most cases, these pins are supplied with air pressure from different sources. In this way, the individual lumen sizes can be adjusted by adjusting the pressure to the individual pins.

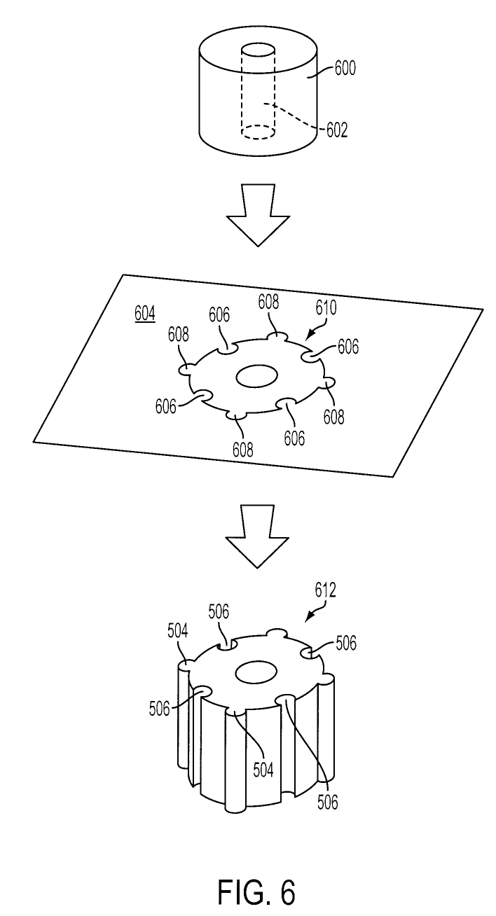

An exemplary method of fabricating the embodiment of FIG. 5 will now be described with reference to FIG. 6.

First, a blank 600 of the material for extrusion is created by known methods. If the extrusion is to have a cable in the interior section, this cable 602 may be formed into blank 600 by known methods. Next, blank 600 is forced by known methods through a die 604 with a cross-section 610 resembling the cross-section of extrusion 500 in FIG. 5. Die 604 has a general circumference corresponding to main body portion 502. Die 604 also has indentations 606 to create female indentions 504 and notches 608 to create male protrusions 502. Once blank 600 has been forced through die 604, the resulting product 612 is the finished extrusion. Product 612 includes the male protrusions 502 and female indentations 504 as shown in FIG. 5.

The embodiments discussed above include a cable therein. Embodiments of the present invention have a hollow core, to facilitate housing of cables after fabrication of the extrusion. Exemplary embodiments of the present invention having a hollow core will now be described with reference to FIGS. 7-10.

Another embodiment of the present invention will now be described with reference to FIG. 7. In this embodiment, extrusion 700 includes a main body portion 702 having a hollow interior section 704. Access to interior section 704 is available from a slit 706 in main body portion 702. Unlike the extrusion shown in FIG. 1, extrusion 700 does not contain a cable in interior section 704. This allows for application of extrusion 700 around a cable or other material after extrusion 700 is fabricated.

Another embodiment of the present invention will now be described with reference to FIG. 8.

In this embodiment, extrusion 800 includes a main body portion 802 having a hollow interior section 804 and a slit 806 to allow access to interior section 804. One side 814 of slit 806 includes a male protrusion 810. The opposite side 812 of the slit 806 includes a female indentation 808 that corresponds to the size and shape of male protrusion 810. Male protrusion 810 and female indentation 808 are shaped to facilitate detachable connection with each other, to hold main body portion 802 closed during normal use. Extrusion 800 may receive a cable or other material therein by first opening main body portion 802 at slit 806, by inserting cable or other material, and then connecting male protrusion 810 to female indentation 808 to secure cable or other material within interior section 804. Slit 806 may later be reopened to replace the cable or other material within interior section 804.

Further, the exemplary embodiment discussed above with respect to FIG. 7 and FIG. 8 includes a single male protrusion and a single female indentation on the periphery of the extrusion. Other embodiments of the present invention include a plurality of male protrusions, a plurality of female indentations and pluralities of both male protrusions and female indentations.

Another embodiment of the present invention will now be described with reference to FIG. 9.

In this embodiment, extrusion 900 includes a main body portion 902 having a hollow interior section 904. Access to interior section 904 is available from a slit 906 in main body portion 902. Unlike the extrusion shown in FIG. 5, extrusion 900 does not contain a cable in interior section 904. This allows for application of extrusion 900 around a cable or other material after extrusion 900 is fabricated. Further, extrusion 900 includes gaps 908 opposite male protrusions 912. Gaps 908 allow extra space in interior section 904 to allow larger or more cables in interior section 904. Additionally, gaps 908 allow for extrusion 900 to be made out of less material than a similar embodiment without the gaps. Extrusion 900 also includes reinforcing sections 910 behind female indentations 914. Reinforcing sections 910 provide structural support to respective female indentations 914.

The exemplary embodiments of the present invention illustrated in FIGS. 7-9 include male protrusions and female indentations having respective wide portions with a circular cross-section. Of course, any shape of cross-section may be used so long as the width of the wide section is equal to or greater than the width of the narrow section, to facilitate detachable connection.

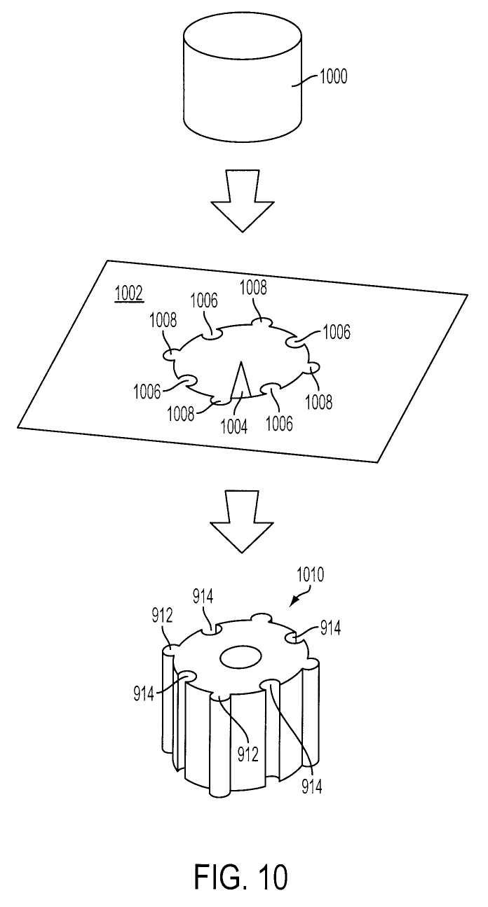

An exemplary method of fabricating an extrusion in accordance with the present invention will now be described with reference to FIGS. 9-10.

First, a blank 1000 of the material for extrusion is created by known methods. Next, blank 1000 is forced by known methods through a die 1002 with a cross-section resembling the cross-section of extrusion 900 in FIG. 9. Die 1002 has general circumference corresponding to main body portion main body portion 902. Die 1004 also has indentations 1006 to create female indentions 914 and notches 1008 to create male protrusions 912. A pin 1004 or a piercing mandrel is then placed in the path of blank 1000 to cut a hollow interior as blank 1000 is forced through die 1002. Once blank 1000 has been forced through die 1002, the resulting product 1010 is the finished extrusion. Product 1010 includes male protrusions 912 and female indentations 914 as shown in FIG. 9.

The present invention provides benefits over conventional cable organization techniques. Unlike conventional methods of cable organization, the present invention allows for individual cables to be replaced or removed without undoing the current organization of the other cables that are organized. Additionally, the present invention allows for great ease in connecting and disconnecting exemplary extrusions to enable simpler organization of a multitude of cables versus conventional methods.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device comprising:
a cable having a periphery; and
an extrusion surrounding said periphery of said cable, said extrusion comprising a main body portion, and at least one of a male protrusion and a female indentation,
wherein said main body portion has an outer periphery,
wherein when said extrusion comprises said male protrusion, said male protrusion is disposed at said outer periphery, and
wherein when said extrusion comprises said female indentation, said female indentation is disposed at said outer periphery.

2. The device of claim 1, wherein said extrusion comprises said male protrusion.

3. The device of claim 2, wherein said extrusion further comprises a second male protrusion disposed at said outer periphery.

4. The device of claim 2,
wherein said male protrusion comprises a first male portion having a first male cross-sectional width and a second male portion having a second male cross-sectional width,
wherein said second male portion is disposed between said first male portion and said outer periphery, and
wherein said first male cross-sectional width is larger than said second male cross-sectional width.

5. The device of claim 1, wherein said extrusion comprises said female indentation.

6. The device of claim 5, wherein said extrusion further comprises a second female indentation disposed at said outer periphery.

7. The device of claim 5,
wherein said female indentation comprises a first female portion having a first female cross-sectional width and a second female portion having a second female cross-sectional width,
wherein said second female portion is disposed between said first female portion and said outer periphery, and
wherein said first female cross-sectional width is larger than said second female cross-sectional width.

8. The device of claim 1, wherein said extrusion comprises said male protrusion and said female indentation.

9. The device of claim 8,
wherein said male protrusion comprises a first male portion having a first male cross-sectional width and a second male portion having a second male cross-sectional width,
wherein said second male portion is disposed between said first male portion and said outer periphery,
wherein said first male cross-sectional width is larger than said second male cross-sectional width
wherein said female indentation comprises a first female portion having a first female cross-sectional width and a second female portion having a second female cross-sectional width,
wherein said second female portion is disposed between said first female portion and said outer periphery, and
wherein said first female cross-sectional width is larger than said second female cross-sectional width.

10. The device of claim 8, wherein said extrusion further comprises a second male protrusion disposed at said outer periphery.

11. The device of claim 10, wherein said extrusion further comprises a second female indentation disposed at said outer periphery.

12. The device of claim 8, wherein said extrusion further comprises a second female indentation disposed at said outer periphery.

13. An extrusion comprising:
main body portion having an outer periphery, a hollow core and a slit from said outer periphery to said hollow core; and
at least one of a male protrusion disposed at said outer periphery and a female indentation disposed at said outer periphery.

14. The extrusion of claim 13, further comprising said male protrusion.

15. The extrusion of claim 14,
wherein said male protrusion comprises a first male portion having a first male cross-sectional width and a second male portion having a second male cross-sectional width,
wherein said second male portion is disposed between said first male portion and said outer periphery, and
wherein said first male cross-sectional width is larger than said second male cross-sectional width.

16. The extrusion of claim 13, further comprising said female indentation.

17. The extrusion of claim 16,
wherein said female indentation comprises a first female portion having a first female cross-sectional width and a second female portion having a second female cross-sectional width,
wherein said second female portion is disposed between said first female portion and said outer periphery, and
wherein said first female cross-sectional width is larger than said second female cross-sectional width.

18. The extrusion of claim 13,
wherein a cross-section shape of said main body portion comprises a main body female indentation disposed at said slit and a main body male protrusion at said slit, opposite to said main body female indentation, and
wherein said main body portion is pliable between a first position in which said main body male protrusion is disposed within said main body female indentation such that said slit is closed and a second position in which said main body male protrusion is not disposed within said main body female indentation such that said slit is open.

19. The extrusion of claim 13,
wherein said outer periphery comprise a first portion and a second portion,
wherein said first portion is disposed between said hollow core and said female indentation,
wherein said second portion is disposed between said hollow core and said male protrusion,
wherein a thickness of said first portion is equal to or greater than a thickness of said second portion.

20. A method comprising:
providing a blank of material;
providing a die having a hole therein, the hole having a shape that includes a center, a perimeter surrounding the center, a notch extending from the perimeter in a direction away from the center, and an indentation extending from the perimeter in a direction toward the center; and
forcing the blank of material through the hole of the die to create an extrusion comprising a main body portion, a male protrusion and a female indentation,
wherein the main body portion has an outer periphery corresponding to the perimeter of the die,
wherein the male protrusion corresponds to the notch and is disposed at the outer periphery, and
wherein the female indentation corresponds to the indentation and is disposed at the outer periphery.
